(19) United States
(12) Patent Application Publication
(10) Pub. No.: US 2024/0155697 A1
(43) Pub. Date: May 9, 2024

(54) COMMUNICATION APPARATUS AND COMMUNICATION METHOD FOR ENHANCED RANDOM ACCESS

(71) Applicant: Panasonic Intellectual Property Corporation of America, Torrance, CA (US)

(72) Inventors: Yanyi DING, Singapore (SG); Rojan CHITRAKAR, Singapore (SG); Yoshio URABE, Nara (JP)

(21) Appl. No.: 18/549,696

(22) PCT Filed: Dec. 23, 2021
(86) PCT No.: PCT/SG2021/050822

§ 371 Date: Sep. 8, 2023

(30) Foreign Application Priority Data
Mar. 12, 2021 (SG) 10202102561V

(51) Int. Cl. H04W 74/0833; H04W 72/02

(52) U.S. Cl. CPC H04W 74/085; H04W 72/02; H04W 84/12

(57) ABSTRACT

Apparatuses and methods for providing multiple structures and methods to enable enhanced random access of access point (AP) controlled resources in a wireless local area network (WLAN) to reduce collisions and increase throughput and efficiency, particularly in high density WLAN environments are provided. The techniques disclosed here feature a communication apparatus including a transceiver and circuitry. The transceiver, in operation, receives signals from and transmits signals to at least one access point in a wireless local area network (WLAN). The circuitry, in operation, demodulates and decodes the signals from the at least one access point, the decoded signals comprising a WLAN transmission including a trigger frame, wherein the circuitry, in operation, prepares a trigger-based WLAN transmission and contends for one or more spatial streams in one of one or more random access resource units (RA-RUs) in response to enhanced uplink OFDMA-based random access (enhanced UORA) being enabled for the communication apparatus.

### BACKGROUND

### 1. Technical Field

The present disclosure relates generally to wireless local area network (WLAN) communication, and more particularly relates to communication apparatuses and communication methods for enhanced random access within WLAN communication systems.

### 2. Description of the Related Art

Communication apparatuses are prevalent in today's world in the form of phones, tablets, computers, cameras, digital audio/video players, wearable devices, game consoles, telehealth/telemedicine devices, and vehicles providing communication functionality, and various combinations thereof. The communication may include exchanging data through, for example, a wireless local area network (LAN) system, a cellular system, a satellite system, and various combinations thereof.

The 802.11 communication protocol uses a carrier sense multiple access (CSMA) method in which the communication apparatuses, such as wireless stations (STA), first sense the channel and attempt to avoid collisions by transmitting only when they sense the channel to be idle (i.e., when 802.11 signals are not detected). When a first STA hears a second STA, the first STA waits for a random amount of time for the second STA to stop transmitting before listening again for the channel to be free. When the first STA is able to transmit, the first STA transmits its whole packet data.

Wi-Fi STAs may use Request to Send/Clear to Send (RTS/CTS) to mediate access to the shared medium. The Access Point (AP) issues a CTS packet to one STA at a time, which in turn sends its entire frame to the AP. The STA then waits for an acknowledgement packet (ACK) from the AP indicating that the AP received the packet correctly. If the STA does not receive the ACK in time, the STA assumes the packet collided with some other transmission, moving the STA into a period of binary exponential backoff. The STA will then try to access the medium and re-transmit its packet after the backoff counter expires.

Although this Clear Channel Assessment and Collision Avoidance protocol serves well to divide the channel somewhat equally among all participants within the collision domain, its efficiency decreases when the number of participants grows very large such as in airport, stadium, mall and other high-density WiFi usage environments. Another factor that contributes to network inefficiency is having many APs with overlapping areas of service.

Thus, there is a need for communication apparatuses and communication methods for enhanced random access of AP controlled resources to alleviate the aforementioned issues, particularly in high density WLAN environments. Furthermore, other desirable features and characteristics will become apparent from the subsequent detailed description and the appended claims, taken in conjunction with the accompanying drawings and this background.

### SUMMARY

One non-limiting and exemplary embodiment facilitates providing multiple structures and methods to enable enhanced random access of access point (AP) controlled resources in a wireless local area network (WLAN) to reduce collisions and increase throughput and efficiency, particularly in high density WLAN environments.

In an exemplary embodiment, a communication apparatus including a transceiver and circuitry. The transceiver, in operation, receives signals from and transmits signals to at least one access point in a wireless local area network (WLAN). The circuitry, in operation, demodulates and decodes the signals from the at least one access point, the decoded signals comprising a WLAN transmission including a trigger frame, wherein the circuitry, in operation, prepares a trigger-based WLAN transmission and contends for one or more spatial streams in one of one or more random access resource units (RA-RUs) in response to enhanced uplink OFDMA-based random access (enhanced UORA) being enabled for the communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1, comprising FIGS. 1A, 1B and 1C, shows an exemplary wireless local area network (WLAN) system and communication apparatuses operating therein, wherein FIG. 1A depicts the exemplary WLAN system, FIG. 1B depicts an exemplary wireless station (STA) communication apparatus, and FIG. 1C depicts a wireless access point (AP);

FIG. 2 is an illustration of a user info field format in a High Efficiency WLAN system;

FIG. 3 is an illustration of a Trigger frame in an exemplary UORA procedure;

FIG. 4 is an illustration of wireless stations (STAs) in the exemplary UORA procedure of FIG. 3;

FIG. 5 is an illustration of a Trigger frame in accordance with the present disclosure when the enhanced UORA is enabled by an explicit indication in the Trigger frame;

FIG. 6 is an illustration of a UORA Parameter Set element in accordance with the present disclosure when the enhanced UORA is enabled by an explicit indication in an element;

FIG. 7, comprising FIGS. 7A and 7B, is an illustration of options for reducing unfairness utilizing an OFDMA contention window (OCW) design in accordance with the present disclosure, wherein FIG. 7A depicts a UORA Parameter Set element format in accordance with a first option and FIG. 7B depicts a UORA Parameter Set element format in accordance with a second option;

FIG. 8 is an illustration of a Trigger frame in an enhanced UORA procedure in accordance with the present disclosure;

FIG. 9 is an illustration of an Extreme High Throughput (EHT) trigger based (TB) physical layer protocol data unit (PPDU) transmitted by a STA in accordance with the present disclosure;

FIG. 10 is an illustration of a Trigger frame when the Spatial Stream (SS) range is implicitly indicated in accordance with the present disclosure;

FIG. 11 is an illustration of a first option of a Trigger frame when the SS range is explicitly indicated in accordance with the present disclosure;

FIG. 12 is an illustration of a second option of a Trigger frame when the SS range is explicitly indicated in accordance with the present disclosure;

FIG. 13 is a flowchart of a TB PPDU reception procedure performed by an AP in accordance with the present disclosure;

FIG. 14 is a flowchart of an EHT TB PPDU transmission procedure performed by a STA in accordance with the present disclosure;

FIG. 15 is a flowchart of an EHT TB PPDU transmission procedure performed by a STA according to specific criteria in accordance with the present disclosure;

FIG. 16 is an illustration of a trigger frame for random selection of one or more than one SS in accordance with the present disclosure;

FIG. 17, comprising FIGS. 17A and 17B, is an illustration of a User info fields for partially random selection of multiple SSs in accordance with the present disclosure, wherein FIG. 17A depicts a User Info field indicating SS range and limitations of SS and FIG. 17B depicts a User Info field for RA-RU assignment using an Uplink (UL) Dual Sub-Carrier Modulation (DCM) field;

FIG. 18 is a flowchart of an EHT TB PPDU transmission procedure performed by a STA in accordance with the present disclosure;

FIG. 19 is an illustration of a mixed UORA trigger frame in accordance with the present disclosure;

FIG. 20 is an illustration of a Trigger frame format assigning the available SSs in allocated RUs for random access in accordance with the present disclosure;

FIG. 21 is an illustration of a Trigger frame for indication of spatial resources for random access in accordance with the present disclosure;

FIG. 22 is a flowchart of EHT TB PPDU transmission procedure performed by a STA when receiving a Trigger frame with RA-SS assignment in accordance with the present disclosure;

And FIG. 23 is a flowchart of a TB PPDU reception procedure performed by the AP in accordance with the present disclosure when one or more RA-RU are assigned.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description. It is the intent of the present disclosure to present exemplary embodiments of communication apparatuses and communication methods for enhanced random access in wireless local area network (WLAN) systems, including enhancement of uplink orthogonal frequency division multiple access (OFDMA)-based random access (UORA).

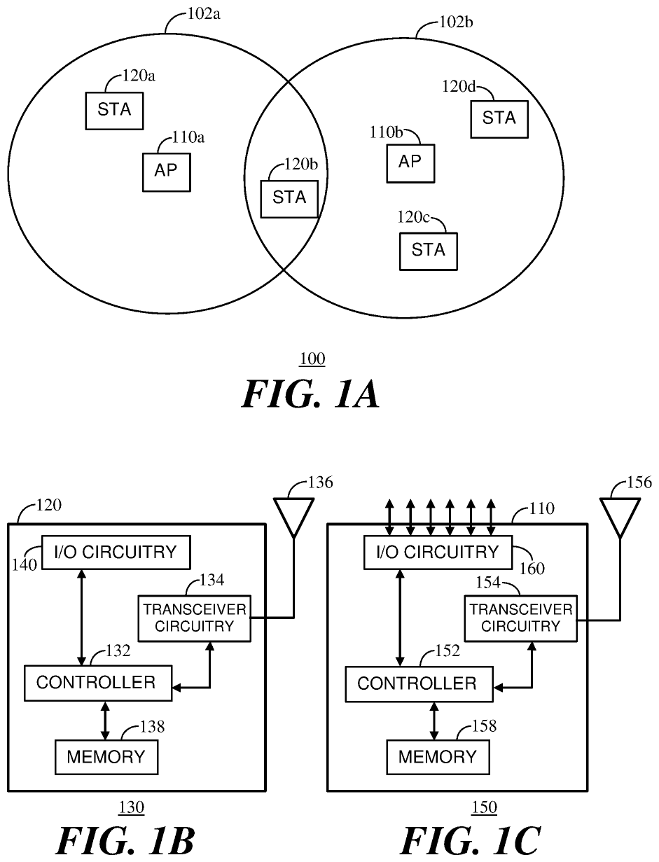

FIG. 1A is an illustration 100 which depicts an exemplary WLAN system. Each access point (AP) 110a, 110b has a corresponding area of service (Basic Service Set (BSS)) 102a, 102b. In a dense WLAN environment, the location of the APs 110a, 110b will be defined to have overlapping areas of service 102a, 102b as shown in the illustration 100 for improved service coverage. Within the areas of service 102a, 102b, wireless stations (STAs) 120a, 120b, 120c, 120d communicate with the APs 110a, 110b.

The wireless stations (STAs) are communication apparatuses operating in a WLAN system. FIG. 1B is a block diagram 130 of an exemplary STA 120. The STA 120 may comprise a device such as a controller 132 which is coupled to a communication device, such as a transceiver 134, connected to an antenna 136 for performing a function of communication as described in the present disclosure. For example, the STA 120 may comprise the controller 132 that generates control signals and/or data signals which are used by the transceiver 134 to perform a communication function of the STA 120. The STA 120 may also comprise a memory 138 coupled to the controller 132 for storage of instructions and/or data for generation of the control signals and/or data signals by the controller 132. The STA 120 may also include input/output (I/O) circuitry 140 coupled to the controller 132 for receiving input of data and/or instructions for storage in the memory 138 and/or for generation of the control signals and/or data signals and for providing output of data in the form of audio, video, textual or other media.

The STAs 120 communicate with the access points (APs) 110 in the WLAN system 100 to access resource units (RU) for exchanging data with the internet, other communication apparatuses or other systems. FIG. 1C is a block diagram 150 of an exemplary AP 110. The AP 110 comprises an infrastructure facility which communicates with or controls STAs 120a, 120b, 120c, 120d such as those illustrated in FIG. 1A or 1B or other communication apparatuses. The AP 110 may comprise a device such as a controller 152 which is coupled to a communication device, such as a transceiver 154, connected to an antenna 156, for performing a function of communication as described in the present disclosure. For example, the AP 110 may comprise the controller 152 that generates control signals and/or data signals which are used by the transceiver 154 to perform a communication function of the AP 110 with the STAs 120. The AP 110 may also comprise a memory 158 coupled to the controller 152 for storage of instructions and/or data for generation of the control signals and/or data signals by the controller 152. The AP 110 may also include input/output (I/O) circuitry 160 coupled to the controller 152 for coupling with various RUs and for receiving input of data and/or instructions for storage in the memory 158 and/or for generation of the control signals and/or data signals to enable communication between the STAs 120 to the RUs.

To address dense environments, WLAN uses the IEEE 802.11ac or IEEE 802.11ax protocol as a communication method. To improve spectrum efficient utilization, a next-generation radio access technology referred to as Extremely High Throughput (EHT) introduces better power-control methods to avoid interference with neighboring networks, orthogonal frequency-division multiple access (OFDMA), higher order 1024-QAM, and up-link MU-MIMO within OFDMA added to the down link of MIMO and MU-MIMO to further increase throughput, as well as dependability improvements of power consumption and security protocols. EHT will be backward compatible with IEEE 802.11a/b/g/n/ac/ax technologies. Also, in IEEE 802.11ax High Efficiency (HE) WLAN, uplink OFDMA-based random access (UORA) is a mechanism for STAs to randomly select RUs assigned by an AP in a Trigger frame. However, there has not been much discussion on enhancement of UORA.

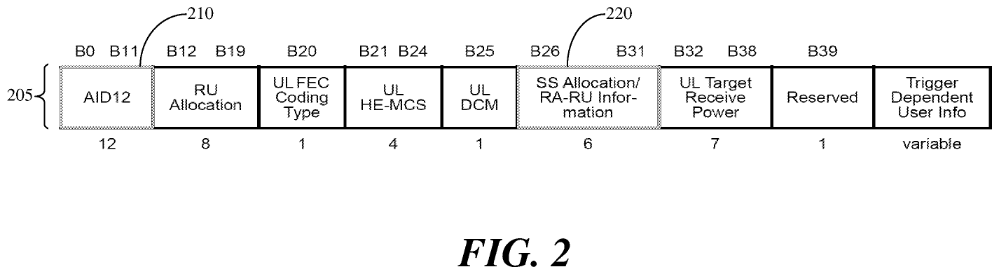

FIG. 2 depicts a User Info field format 200 in accordance with UORA indication in HE WLAN. An AP 110 in a HE WLAN system may transmit a Basic Trigger frame, a Bandwidth Query Report Poll (BQRP) Trigger frame or a Buffer Status Report Poll (BSRP) Trigger frame in a User Info field 205 that contains one or more RUs for random access by a STA 120. A first subfield having an Association ID (AID12) 210 indicates whether the User Info field 205 is for random access for associated STAs or unassociated STAs. When the first subfield 210 is ‘0’, the User Info field 205 is for random access for associated STAs; and when the first subfield 210 is ‘2045’, the User Info field 205 is for random access for unassociated STAs.

The STA 120 with pending frames for the AP 110 that is not the intended receiver of the User Info field 200 may contend for random access RUs (RA-RUs) if it can transmit a HE trigger-based (TB) physical layer protocol data unit (PPDU) in the RA-RU according to the parameters indicated in the Common Info field and in the User Info field 205. A SS Allocation/RA-RU Information field 220 in the User Info field 205 may indicate RA-RU allocated for UORA. When the value of the AID12 subfield 210 is ‘0’ or ‘2045’, only RA-RU Information is contained in this field. The RA-RU Information in the SS Allocation/RA-RU Information field 220 indicates the number of contiguous RUs allocated for UORA. There is no indication for Spatial Stream (SS) Allocation in the User Info field 205 for random access.

Upon the reception of a Trigger frame containing at least one eligible RA-RU, the STA 120 decrements its OFDMA Backoff (OBO) counter by the number of eligible RA-RUs (e.g., as indicated by the SS Allocation/RA-RU Information field 220). A non-AP STA may consider an RU as an eligible RA-RU if it supports all the transmit parameters indicated in the Common Info field and in the User Info field 205 that allocates that RU. If the result is not greater than zero, then the STA 120 sets its OBO counter to zero and randomly select one of the eligible RA-RUs to be considered for transmission. Otherwise, the STA 120 maintains the new OBO value until a next UORA.

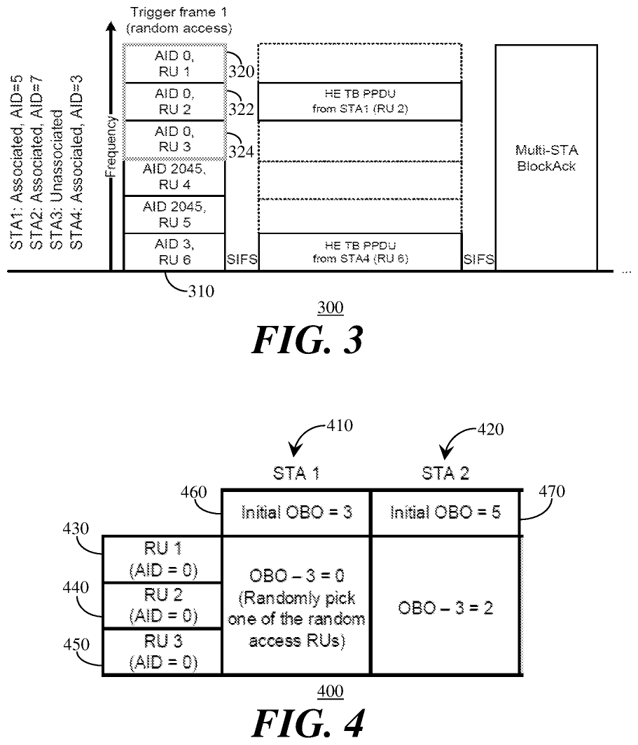

FIG. 3 is an illustration 300 of a Trigger frame 310 (trigger frame 1 (random access)) with three User Info fields 320, 322, 324 sent by an AP. The AP sends the Trigger frame 310 with each of the three User Info fields 320, 322, 324 having an AID value of zero, meaning the RUs (RU1, RU2, RU3) are regarded as RA-RUs for associated STAs. STA1 and STA2 are not intended receivers because their AIDS are not present in the User Info field. But STA1 and STA2 both have pending frames for the AP. Therefore, STA1 and STA2 contend for the eligible RA-RUs.

FIG. 4 is an illustration 400 of a STA1 410 and STA2 420 contending for the eligible RA-RUs: RU1 430, RU2 440, and RU3 450. In accordance with UORA procedure, STA1 410 and STA2 420 decrement their respective OBO counters by the number of eligible RA-RUs (i.e., by “3”). STA1 410 has an initial OBO counter value 460 of “3” and STA2 420 has an initial OBO counter value 470 of “5”. The OBO counter of STA1 410 decrements to zero. So STA1 410 randomly selects RU2 440, one of the random access RUs and transmits pending frames on RU2. The OBO counter of STA2 420 decrements to two, a nonzero value. Therefore, STA2 420 does not transmit and maintains the new OBO value (i.e., “2”) until the STA2 420 receives a later Trigger frame carrying RA-RUs for associated STAs.

In IEEE 802.11ax, a single spatial stream is used for transmission in a RA-RU. If a different STA randomly selects a same RA-RU, a collision is caused and transmission in the RA-RU fails. This is a problem as the maximal efficiency of RA-RU usage (i.e., acceptance rate of RA-RU) in IEEE 802.11ax is 37%. Thus, there is a need for a UORA procedure with more efficiency and higher throughput.

In accordance with the present disclosure an enhanced UORA procedure is carried out to address the problem set out above and provide for increased efficiency and higher throughput. The enhanced UORA procedure in accordance with the present disclosure includes the following steps:
(a) An AP transmits a Trigger frame that contains one or more RA-RUs to non-AP STAs. The STAs that satisfy the conditions for participating in UORA contention are target STAs.
(b) Whether the enhanced UORA is enabled may be indicated as ‘yes’ prior to the UORA procedure if UL MU-MIMO within OFDMA is supported. It is mandatory for non-AP EHT STA to support UL MU-MIMO in the entire band. The enhanced UORA and conventional UORA may be enabled simultaneously in a same trigger-based transmission.
(c) If enhanced UORA is enabled, parameters for TB PPDU transmission in RA-RUs including the information about Spatial Stream (SS) selection are indicated in the Trigger frame.
(d) Upon reception of the Trigger frame, the target STAs contend for the RA-RUs. The STA may then transmit in a randomly selected RA-RU following the parameters indicated in the Trigger frame using SS(s) subject to the information about SS selection indicated in the Trigger frame. The SS(s) used by the STA in RA-RUs need not be limited to the first SS. A n^{th} SS means the corresponding SS when the STARTING_STS_NUM parameter is set to (n−1) in TXVECTOR parameters.
(e) The receiver AP performs blind decoding on TB PPDU in RA-RUs.

When each STA selects only one SS, the AP lacks knowledge of whether the signal exists in each RU plus which STA transmits the signal, if any. This similarity to conventional UORA is advantageous for the enhanced UORA procedure. Also, in accordance with the enhanced UORA procedure of the present disclosure, the UL MU-MIMO within OFDMA is enabled in the RA-RUs and different STAs that select a same RA-RU are likely to select different SSs to transmit. Thus, the collision rate is advantageously decreased and throughput and overall efficiency is increased.

Whether the enhanced UORA is enabled may be indicated in different ways: there can be an explicit indication in a Trigger frame, there can be an explicit indication in the elements, or there can be an implicit indication by parameters in the Trigger frame.

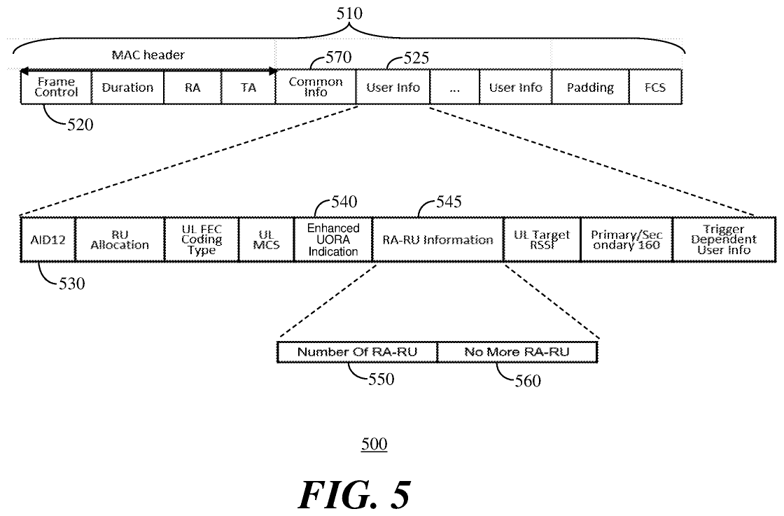

FIG. 5 is an illustration 500 of a Trigger frame 510 when the enhanced UORA is enabled by an explicit indication in the Trigger frame 510. The Trigger frame format 520 includes a User Info field 525. The User Info field format 530 for RA-RU assignment includes the explicit indication of whether enhanced UORA is enabled in an Enhanced UORA Indication field 540. A RA-RU Information field 545 in the User Info field format 530 includes a Number of RA-RU field 550 and a No More RA-RU field 560.

In another possible option, the explicit indication of whether enhanced UORA is enabled may be indicated in the Common Info field 570 in the Trigger frame 510. When the Enhanced UORA Indication field 540 is indicated as “1”, enhanced UORA is enabled for the RA-RUs.

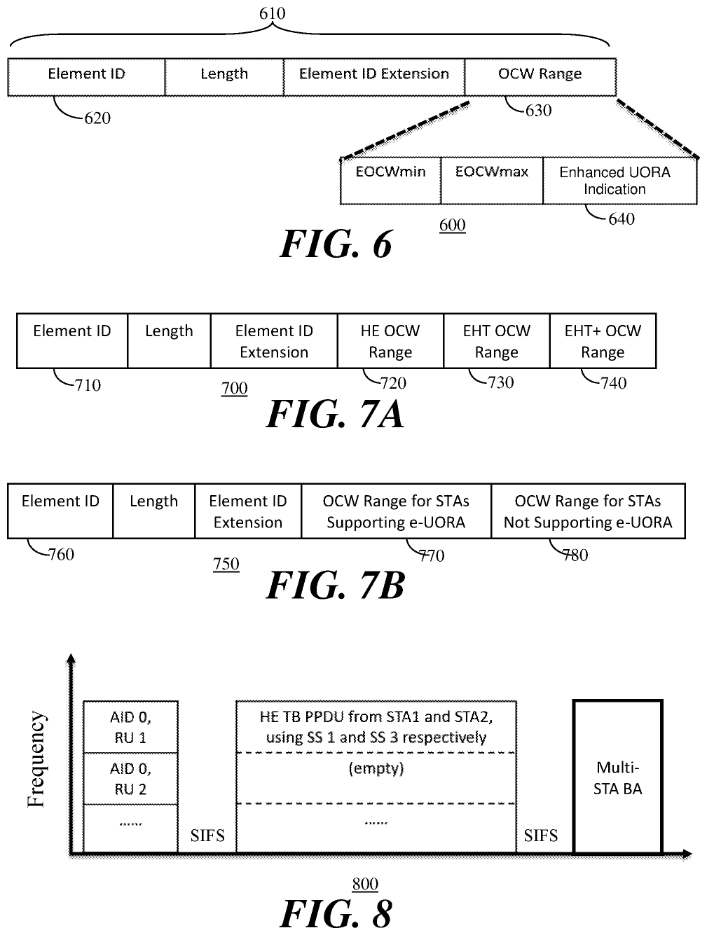

FIG. 6 is an illustration 600 of a UORA Parameter Set element 610 when the enhanced UORA is enabled by an explicit indication in an element. In another possible option, the explicit indication may be included in a Capability element. Within the UORA Parameter Set element format 620, an OFDMA contention window (OCW) range field 630 includes the explicit indication of enablement of enhanced UORA in an Enhanced UORA indication field 640. When the Enhanced UORA Indication field 640 is indicated as “1”, the enhanced UORA is enabled in the Basic Service Set (BSS).

The enhanced UORA may also be enabled implicitly. There are three options for a receiver STA to tell whether enhanced UORA is enabled for an RA-RU. First, the receiver STA can tell from parameters indicated in the Trigger frame, including but not limited to RA-RU size or number of HE/EHT-LTF symbols. Secondly, the receiving STA can tell from capabilities broadcasted by the AP, such as Partial Bandwidth UL MU-MIMO. Finally, when Partial Bandwidth UL MU-MIMO is enabled at the EHT-AP, it also implicitly means the AP is capable of enhanced UORA. In this last option, it is defined that the EHT-AP with that capability supports the reception of TB PPDU by enhanced UORA.

For example, the receiver STA may decide that the enhanced UORA is enabled if the following conditions are satisfied: (a) The RA-RU size indicated in the User Info field supports UL MU-MIMO within OFDMA and (b) The number of HE/EHT-LTF symbols in the Common Info field supports multiple SSs. If either of these conditions are not met, the receiver STA may decide the RA-RU is for conventional UORA (i.e., IEEE 802.11ax-like UORA).

In accordance with the present disclosure, a contention procedure when enhanced UORA is indicated as enabled is carried out by first decrementing the OBO counter. Options for decrementing the OBO counter in accordance with the present disclosure include using the same contention procedure as in conventional UORA, using a contention procedure based on conventional counter decrement (i.e., only based on the number of eligible RA-RUs), and adopting a new OBO counter decrement value. The new OBO counter decrement value in accordance with the present disclosure corresponds to a number of eligible choices. In accordance with the enhanced UORA according to the present disclosure, the number of eligible choices could be a result of the number of eligible RA-RUs multiplied by the number of eligible SSs (e.g., if there are two RA-RUs in which four SSs may be used, then the number of eligible choices would be eight) or could be the result of the number of eligible RA-RUs multiplied by the number of eligible SSs groups (e.g., if there are two RA-RUs in which four SSs may be used and each STA may choose two SSs, then the number of eligible choices is four). Upon reception of a Trigger frame containing at least one eligible RA-RU, the STA decrements its OBO counter by the number of eligible choices. If the result is not greater than zero, then the STA sets its OBO counter to zero and randomly select one of the eligible RA-RUs and select one or more SSs in it to be considered for transmission. Otherwise, the STA maintains the new OBO value until the next UORA or enhanced UORA.

Since there are STAs that are not able to contend for enhanced UORA (e.g., HE STAs or post-HE STAs not supporting enhanced UORA), and if the new OBO counter decrement value is applied, a fairness issue may be caused. STAs that are not able to contend for enhanced UORA may have fewer eligible resources to contend and, thus, have less chance to win the contention.

To reduce the unfairness, two options are presented in accordance with the present disclosure. FIG. 7A depicts an illustration 700 of an OFDMA contention window (OCW) design in a UORA Parameter Set element format 710 in accordance with a first option to reduce the unfairness according to the present disclosure. The UORA Parameter Set element format 710 includes a High Efficiency (EH) OCW Range field 720, an Extremely High Throughput (EHT) OCW Range field 730, and a post Extremely High Throughput (EHT+) OCW Range field 740. This first option defines different OCW ranges for different generations in the OCW Range fields 720, 730, 740 in the UORA Parameter Set element 710. A lower value for OCW range may be set for older generations.

FIG. 7B depicts an illustration 750 of an OFDMA contention window (OCW) design in a UORA Parameter Set element format 760 in accordance with a second option to reduce the unfairness according to the present disclosure. The UORA Parameter Set element format 760 includes an OCW Range for STAs Supporting enhanced UORA (e-UORA) field 770 and an OCW Range for STAs Not Supporting enhanced e-UORA field 780. This second option defines different OCW ranges for STAs with different capabilities (i.e., supporting enhanced UORA or not supporting enhanced UORA) in the capability fields 770, 780 of the UORA Parameter Set element 760. A lower value for OCW range may be set for STAs not supporting enhanced UORA. In this manner, in accordance with either of the two options, the contention chance for STAs that are not able to contend for enhanced UORA may advantageously be improved.

In accordance with the present disclosure, a STA may randomly select a single SS in a RA-RU subject to the capabilities of the STA (i.e., whether the STA supports enhanced UORA or not) and the SS range indicated in the Trigger frame. When an HE trigger-based (TB) physical layer protocol data unit (PPDU) is solicited, a HE STA shall select the first SS. An EHT STA or post-EHT STA, on the other hand, shall select from SSs other than the first SS subject to the SS range.

When an EHT TB PPDU is solicited, the EHT STA or EHT+STA may select any SS subject to the SS range. STAs not supporting UL MU-MIMO within OFDMA may also contend for enhanced UORA.

FIG. 8 is an illustration 800 of a Trigger frame in a UORA RA-RU procedure in accordance with the present disclosure. STA1 (an HE STA) and STA2 (an EHT STA) are target STAs. The SS range for RA-RUs is from SS 1 to SS 4. In accordance with the present disclosure, STA1 randomly selects RU 1 and selects SS 1. STA2 randomly selects RU 1 and randomly selects SS 3. STA1 and STA2 then transmit a TB PPDU in RU 1 using SS 1 and SS 3, respectively. SS 2 and SS 4 are empty. In this manner, the random selection of single SS in accordance with the present disclosure provides low process complexity and low collision rate, and is applicable for both associated and unassociated STAs.

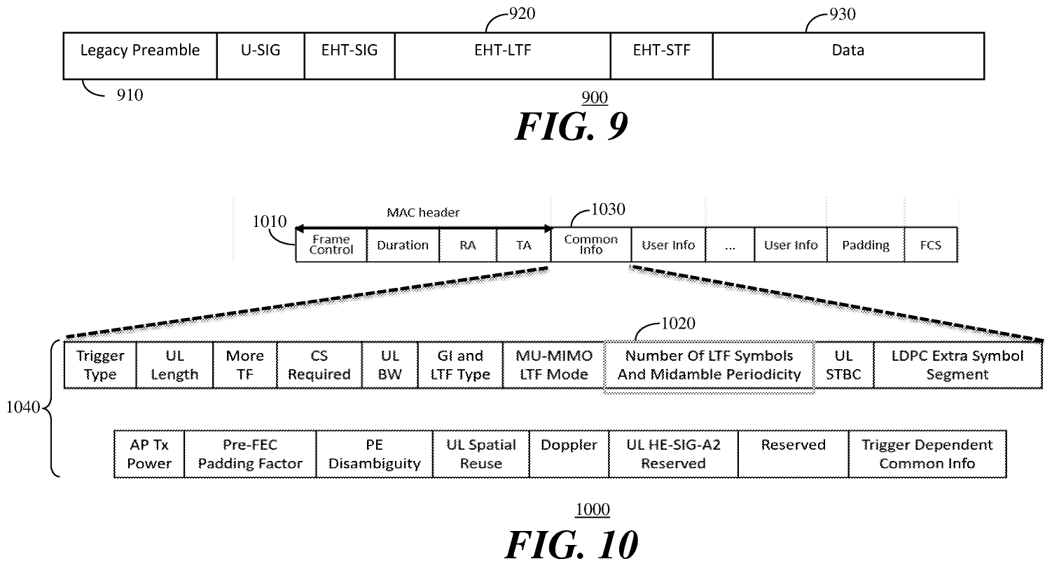

FIG. 9 is an illustration 900 of an EHT TB PPDU 910 in accordance with the present disclosure. When a STA is solicited to transmit an EHT TB PPDU and contends successfully for enhanced UORA, the EHT TB PPDU 910 is prepared and transmitted by the STA. An Extreme High Throughput-Long Training Field (EHT-LTF) field 920 is generated by using P [INDEX_{selectedSS}, 1˜N_{EHT-LTF}], where P is the P matrix and N_{EHT-LTF} is the number of EHT-LTF symbols indicated by the trigger frame. The Number of EHT-LTF symbols generated will be same among all STAs. So, there are N_{EHT-LTF} EHT-LTF symbols in total, carrying channel information for the selected SS and selected RA-RU only. A Data field 930 carries data on selected RA-RU and selected SS.

FIG. 10 is an illustration 1000 of a Trigger frame 1010 when the Spatial Stream (SS) range is implicitly indicated in accordance with the present disclosure. The SS range may be implicitly indicated by the Number of EHT-LTF/HE-LTF Symbols and Midamble Periodicity subfield 1020 of the Common Info field 1030 in the Trigger frame 1010. In the Common Info field format 1040, the value of the Number of EHT-LTF/HE-LTF Symbols And Midamble Periodicity subfield 1020 (N_{EHT-LTF}/N_{HE-LTF}) may indicate the maximal number of SS that can be used in RA-RUs. The STA may select a single SS from SS 1˜N_{HE/EHT-LTF} to transmit in the RA-RU.

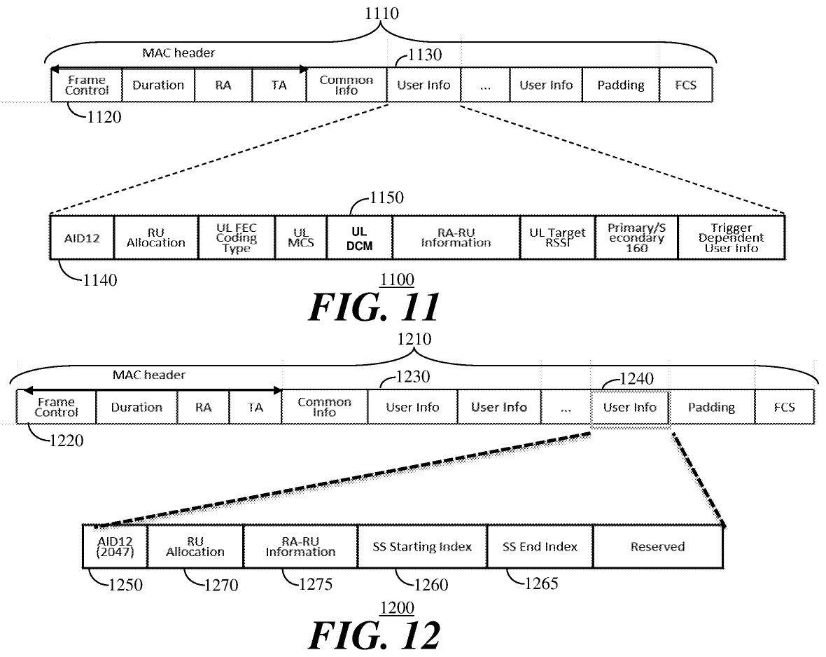

FIG. 11 is an illustration 1100 of a Trigger frame 1110 in accordance with a first option of explicitly indicating the SS range according to the present disclosure. The Trigger frame format 1120 includes a User Info field 1130. The SS range may be explicitly indicated in the User Info field 1130 if a post-HE TB PPDU is solicited and when the enhanced UORA indication is placed in another field/frame instead of the User Info field 1130 in the Trigger frame 1110 (i.e., in the Common Info field, the UORA Parameter Set element, or the capability element). The User Info field format 1140 for RA-RU assignment includes an uplink (UL) Dual Sub-Carrier Modulation (DCM) field 1150. DCM is an optional modulation scheme for the HE-SIG-B and Data fields. The UL DCM field 1150 of one bit may be reused to indicate the maximal number of SS that may be used in RA-RU. For example, “2” or “4” may be used in the UL DCM field 1150 to indicate maximum number of SSs.

FIG. 12 is an illustration 1200 of a Trigger frame 1210 in accordance with a second option of explicitly indicating the SS range according to the present disclosure. The Trigger frame format 1220 includes a User Info field 1230 with RA-RU assignment. The SS range may be explicitly indicated in another User Info field 1240 with a new Association ID (AID) in the Trigger frame 1210. The new User Info field format 1250 indicates the SS range in the RA-RUs by a SS Starting Index subfield 1260 and a SS End Index 1265. A value of an AID12 subfield 1270 may be “2047”, or any value in the range of “2008” to “2044”. The new User Info field 1240 carries the same RU Allocation 1270 and RA-RU Information 1275 as the corresponding User Info field 1230 with RA-RU assignment. Other information about enhanced UORA may be indicated in the new User Info field as well.

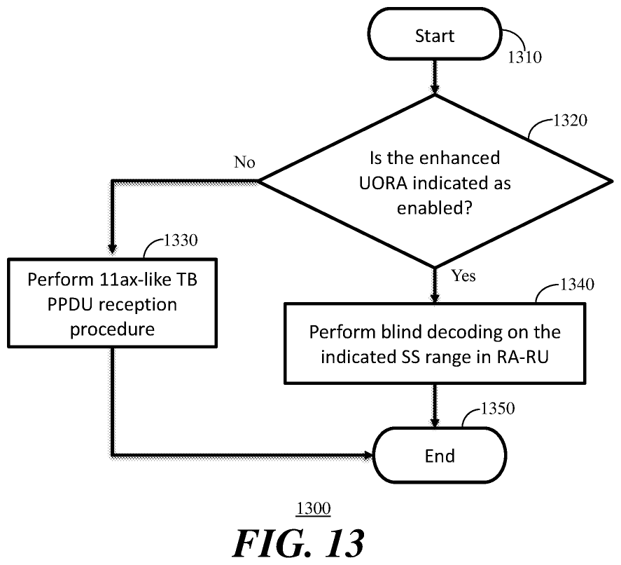

FIG. 13 is a flowchart 1300 of a TB PPDU reception procedure performed by an AP 110 when one or more RA-RU is assigned. The TB PPDU reception procedure starts 1310 by the AP determining 1320 whether enhanced UORA is indicated as enabled. If the enhanced UORA is not indicated as enabled 1320, an IEEE 802.11ax-like TB PPDU reception procedure is performed 1330 and the TB PPDU reception procedure ends 1350.

In accordance with the present disclosure, if the enhanced UORA is indicated as enabled 1320, blind decoding on the indicated SS range is performed 1340. The AP 110 does not know which SS carries data or which STA is transmitting. So, the AP performs 1340 the blind decoding on all possible SSs in each RA-RU. Advantageously, the process is similar to conventional UORA where the AP 110 does not know which RA-RU carries data, so no change is needed for at the AP 110 side. After the blind decoding on the indicated SS range is performed 1340, the TB PPDU reception procedure ends 1350.

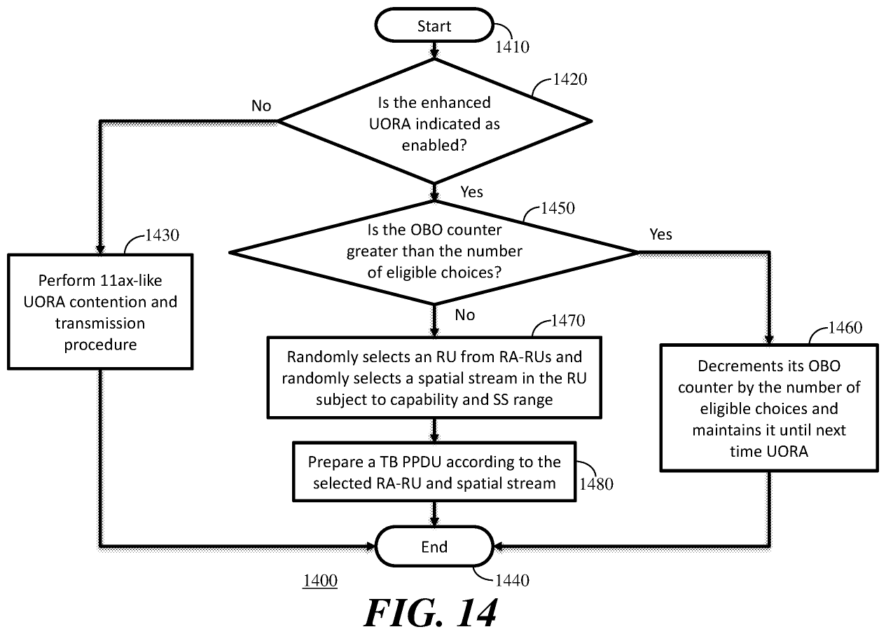

FIG. 14 is a flowchart 1400 of a TB PPDU transmission procedure performed by a STA 120 when receiving a Trigger frame with RA-RU assignment and the STA 120 satisfies the condition for UORA transmission. The TB PPDU transmission procedure starts 1410 by the STA 120 determining 1420 whether enhanced UORA is indicated as enabled. If the enhanced UORA is not indicated as enabled 1420, an IEEE 802.11ax-like UORA contention and transmission procedure is performed 1430 and the TB PPDU transmission procedure ends 1440.

If the enhanced UORA is indicated as enabled 1420, the EHT TB PPDU transmission procedure determines 1450 whether the OBO counter is greater than the number of eligible choices. If the OBO counter is greater than the number of eligible choices 1450, the OBO counter is decremented 1460 by the number of eligible choices and the OBO counter value is maintained until a next UORA. Then the EHT TB PPDU transmission procedure ends 1440.

If the OBO counter is not greater than the number of eligible choices 1450, a RU is randomly selected from the RA-RUs and a spatial stream (SS) is randomly selected in the RU subject to the STA 120 capability and SS range 1470. A TB PPDU is then prepared 1480 according to the selected RA-RU and spatial stream and the EHT TB PPDU transmission procedure ends 1440 by transmitting the TB PPDU.

In accordance with the present disclosure, the STA 120 may select a single SS in the RA-RU subject to capabilities and the SS range indicated in the Trigger frame following specific decision criteria. When HE TB PPDU is solicited, a HE STA shall select the first SS. The EHT STA or a post-EHT STA selects from SSs other than the first SS subject to the SS range. When EHT TB PPDU is solicited, an EHT STA or a post-EHT STA may select any SS subject to the SS range. The possible specific decision criteria may be an Index of SS selected based on the result of the STA's AID mod or the maximal number of SSs that may be used in RA-RU.

For example, assume a target STA1 is with AID 2 and a target STA2 is with AID 5, where STA1 and STA 2 are associated STAs. The STA1 and the STA2 randomly select a same RA-RU and there are four SSs that may be used in the RA-RU. For STA1, N_{AID} mod N_{SS}=2 mod 4=2, so STA1 selects SS 2 to transmit in the RA-RU. For STA2, N_{AID} mod N_{SS}=5 mod 4=1, so STA2 selects SS 1 to transmit in the RA-RU. Thus, in some scenarios where AIDs of target STAs are contiguous, the collision rate may be further decreased than the EHT TB PPDU transmission procedure of the flowchart 1400 by the avoidance of collision in the SS. Note that this is only applicable for associated STAs.

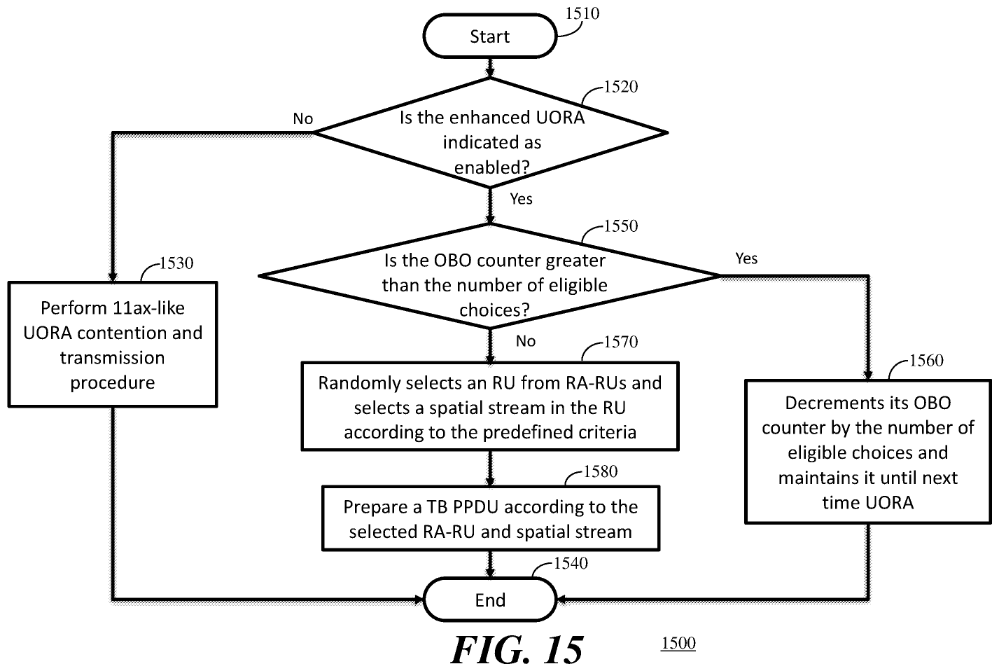

FIG. 15 is a flowchart 1500 of a TB PPDU transmission procedure performed by a STA 120 when receiving a Trigger frame with RA-RU assignment where the STA 120 satisfies the condition for UORA transmission following specific decision criteria. The TB PPDU transmission procedure starts 1510 by the STA 120 determining 1520 whether enhanced UORA is indicated as enabled. If the enhanced UORA is not indicated as enabled 1520, an IEEE 802.11ax-like UORA contention and transmission procedure is performed 1530 and the TB PPDU transmission procedure ends 1540.

If the enhanced UORA is indicated as enabled 1520, the TB PPDU transmission procedure determines 1550 whether the OBO counter is greater than the number of eligible choices. If the OBO counter is greater than the number of eligible choices 1550, the OBO counter is decremented 1560 by the number of eligible choices and the OBO counter value is maintained until a next UORA. Then the TB PPDU transmission procedure ends 1540.

If the OBO counter is not greater than the number of eligible choices 1550, a RU is randomly selected from the RA-RUs and a spatial stream (SS) is selected in the RU according to the specific criteria 1570. A TB PPDU is then prepared 1580 according to the selected RA-RU and spatial stream and the TB PPDU reception procedure ends 1540 by transmitting the TB PPDU.

The STA 120 may randomly select one or more SSs in the RA-RU subject to capabilities (e.g., the maximal number of SSs the STA supports) and the SS range indicated in the Trigger frame. The number and index of SS(s) are decided by the STA 120 itself based on its requirements. For example, if the pending frames held by the STA 120 can only be transmitted with at least two SSs in the RA-RU according to the indicated parameters, then the STA may select two SSs to transmit. For simplicity, the index of multiple SSs selected by STA are contiguous. When HE TB PPDU is solicited, a HE STA shall select the first SS. An EHT STA or a post-EHT STA selects from SSs other than the first SS subject to the SS range. In addition, an EHT STA or a post-EHT STA may select two or more SSs if the AP 110 is capable of blind decoding. These procedures are applicable for both associated and unassociated STAs 120. While the random selection of multiple SSs provides higher throughput than non-random selection of a single SS (i.e., non-random selection being subject to the STAs capability and SS range or being subject to the specific criteria), the trade-off is the higher complexity required by the random selection of multiple SSs.

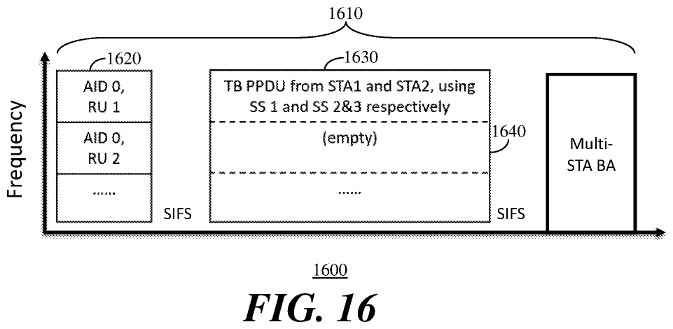

FIG. 16 is an illustration 1600 of a trigger frame for random selection of multiple SSs in accordance with the present disclosure. Assume a STA1 and a STA2 are target STAs, that the STA1 only supports one SS transmission, while the STA2 supports two SS transmissions, and the SS range for RA-RUs is from SS 1 to SS 4. The STA1 randomly selects RU 1 and randomly selects SS 1. The STA2 randomly selects RU 1 and randomly selects SS 2 and SS 3. As shown in the Trigger frame 1610, in RU 1 1620, the STA1 and the STA2 transmit their TB PPDU 1630 using SS 1 and SS 2/SS 3, respectively. The SS 4 1640 is empty.

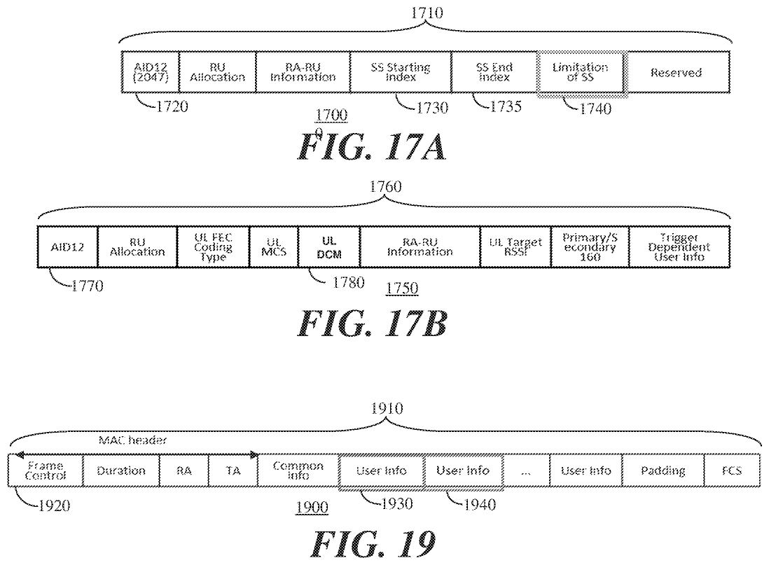

FIG. 17A and FIG. 17B depict illustrations 1700, 1750 of User Info fields 1710, 1760 for partially random selection of multiple SSs in accordance with the present disclosure. The STA may randomly select one SS or more than one SS in the RA-RU subject to the STA's capabilities and the SS range together with other limitations of SS indicated in the Trigger frame. The limitation of SS, for example, may be the maximal number of SS a STA may select. The Index of SS(s) may also be decided by STA itself, where the number of SS(s) is subject to limitations indicated in the Trigger frame. For simplicity, the index of multiple SSs selected by a STA are contiguous.

The illustration 1700 depicts a new User Info field format 1720 for the User Info field 1710 to indicate SS range and limitations of SS. The SS range is indicated by a SS Starting Index subfield 1730 and a SS End Index subfield 1735. The limitations of the SS are indicated by a Limitation of SS subfield 1740.

The illustration 1750 depicts a User Info field format 1770 for the User info field 1760 for RA-RU assignment. A UL DCM subfield 1780 is used for random access and for indication of SS limitations.

The STA 120 may also select one SS or more than one SS in the RA-RU subject to capabilities and the SS range and limitation of SS indicated in the Trigger frame in accordance with the present disclosure following specific decision criteria. The possible redefined decision criteria may be an Index of SS which is selected based on the result of the STA's AID mod and the number of SS groups.

If a Target STA1 is with AID 2 and a target STA2 is with AID 5, the STA1 and the STA2 are associated STAs, the STA1 and the STA2 randomly select a same RA-RU, there are eight SSs which may be used in the RA-RU and the maximal number of SS a STA may select is 2, the selection of SS is governed by Equation (1).

N_{SSgroups}=N_{SS}/N_{SS,u,max} (1)

where, N_{SSgroups} is the number of SS groups, and N_{SS,u,max} is the maximal number of SSs which may be selected by a STA. For STA1, N_{AID} mod N_{SSgroups}=2 mod 4=2; so STA1 selects a SS from SS group 2, which contains SS 3 and SS 4. For STA2, N_{AID} mod N_{SSgroups}=5 mod 4=1; so STA2 selects a SS from SS group 1, which contains SS 1 and SS 2. STA1 and STA2 transmits TB PPDU in the RA-RU using SS 3/SS 4 and SS 1/SS 2, respectively. The other SSs in the RA-RU are empty. Note that this nonrandom selection of multiple SS procedure is only applicable for associated STAs.

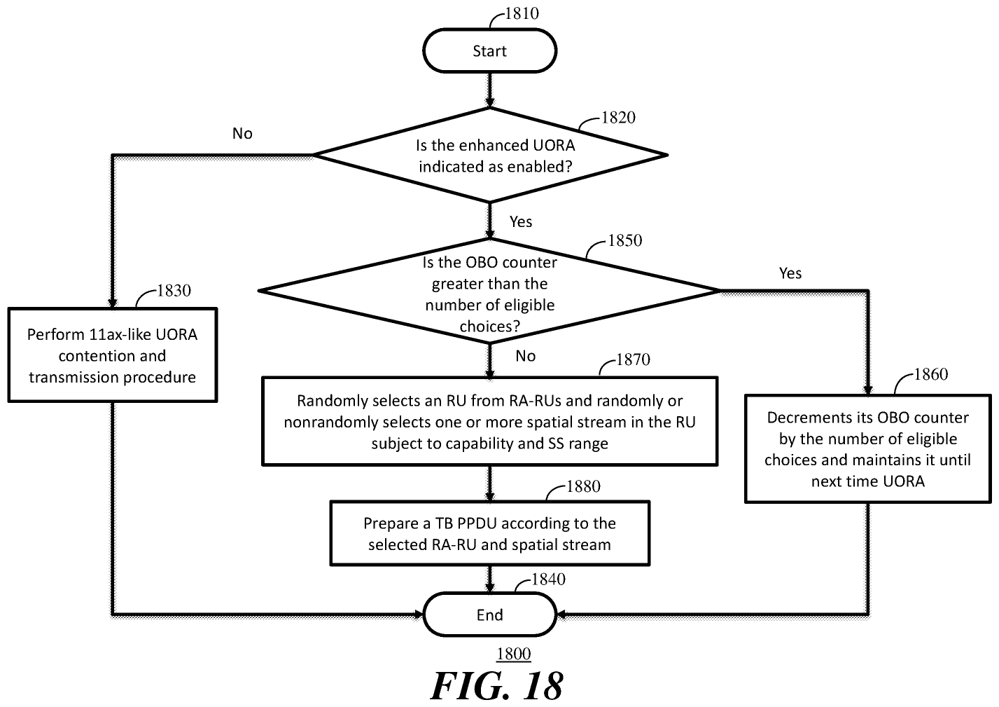

FIG. 18 is a flowchart 1800 of a TB PPDU transmission procedure performed by a STA when receiving a Trigger frame with RA-RU assignment and the STA satisfies the condition for UORA transmission. The EHT TB PPDU transmission procedure starts 1810 by the STA 120 determining 1820 whether enhanced UORA is indicated as enabled. If the enhanced UORA is not indicated as enabled 1820, an IEEE 802.11ax-like UORA contention and transmission procedure is performed 1830 and the TB PPDU transmission procedure ends 1840.

If the enhanced UORA is indicated as enabled 1820, the TB PPDU transmission procedure determines 1850 whether the OBO counter is greater than the number of eligible choices. If the OBO counter is greater than the number of eligible choices 1850, the OBO counter is decremented 1860 by the number of eligible choices and the OBO counter value is maintained until a next UORA. Then the TB PPDU transmission procedure ends 1840.

If the OBO counter is not greater than the number of eligible choices 1850, a RU is randomly selected from the RA-RUs and one or more spatial streams (SSs) are randomly or nonrandomly selected in the RU subject to the STA 120 capability and the SS range 1870. A TB PPDU is then prepared 1880 according to the selected RA-RU and spatial stream and the EHT TB PPDU transmission procedure ends 1840 by transmitting the TB PPDU.

Enhanced UORA and conventional UORA may be enabled simultaneously in a same trigger-based transmission. FIG. 19 depicts an illustration 1900 of a mixed UORA trigger frame 1910 carrying RA-RU assignment for both conventional and enhanced UORA transmitted to STAs. The Trigger frame format 1920 includes at least a first User Info field 1930 and a second User Info field 1940. The first User Info field 1930 carries the RA-RU assignment for conventional UORA. The second User Info field 1940 carries the RA-RU assignment for enhanced UORA. When receiving the Trigger frame 1910, STAs supporting enhanced UORA and STAs not supporting enhanced UORA may both contend for eligible RA-RUs for conventional UORA. However, STAs supporting enhanced UORA may also contend for eligible SSs in eligible RA-RUs for enhanced UORA. STAs not supporting enhanced UORA may contend for only the first SS in eligible RA-RUs for enhanced UORA. A new OCW design may be applied to reduce the fairness issue.

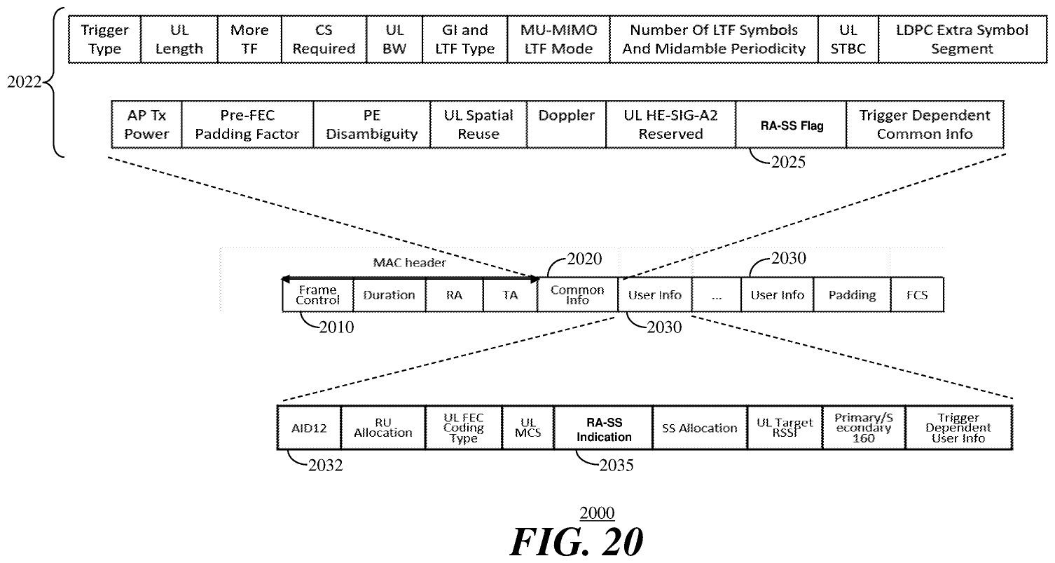

FIG. 20 is an illustration 2000 depicting an exemplary Trigger frame format 2010 for assigning the available SSs in allocated RUs for random access. In accordance with the present disclosure, the AP may assign the available SSs in allocated RUs for random access. However, such assignment may involve high process complexity. The Trigger frame format 2010 includes a Common Info field 2020 and a User Info field 2030. A Common Info field format 2022 in accordance with the present disclosure includes a RA-SS Flag subfield 2025 and a User info field format 2032 for an allocated RU in accordance with the present disclosure includes a RA-SS indication subfield 2035.

The AP may indicate whether there is any spatial resource in any of the allocated RUs which can be used for random access in the RA-SS Flag subfield 2025 in the Common Info field 2020 or indicate it in a UORA Parameter Set element. When the RA-SS Flag subfield 2025 is indicated as “1”, the AP may indicate whether the SS in an allocated RU can be used for random access in the RA-SS Indication subfield 2035 in the corresponding User Info field 2030. When the RA-SS Flag subfield 2025 is indicated as “1”, the STA checks the RA-SS Indication subfield 2035 in each User Info field 2030 until the end of the User Info fields or until the STA finds the matching AID.

The User Info field 2030 in which RA-SS Indication subfield 2035 is indicated as “1” carries the last allocated SS information and the STA may decide the index of the RA-SS by the SS range information (e.g., number of LTF symbols) and the SS information indicated in the User Info field 2030.

The number of eligible choices is determined in accordance with the present disclosure according to Equation 2.

N_{SS,RA-RU,total}+N_{RA-SS,total} (2)

where N_{SS,RA-RU,total} is the total number of spatial streams that may be used in the RA-RUs and N_{RA_SS,total} is the total number of RA-SS.

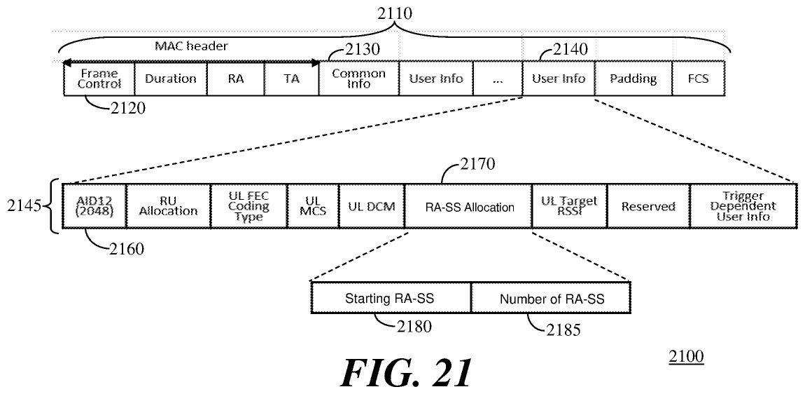

FIG. 21 is an illustration 2100 of a Trigger frame 2110 having a Trigger frame format 2120 for indication of spatial resources for random access in accordance with the present disclosure. The AP may indicate whether there is any spatial resource in any of the allocated RUs which can be used for random access in a RA-SS Flag subfield in the Common Info field 2130 or may indicate in a UORA Parameter Set element. The information about RA-SS may be indicated in a User Info field 2140 with a new AID. Referring to the User Info field format 2145 for RA-SS, the value of the AID12 subfield 2160 may be “2048”, “2047” or any value in the range of “2008” to “2044”. If the AID12 value in the AID12 subfield 2160 equals “2048”, the User Info field 2140 shall be located after User Info fields with AID less than 2048. A RA-SS Allocation subfield 2170 may be similar to a SS Allocation subfield, carrying information about the starting RA-SS 2180 and the number of RA-SS 2185. This provides lower process complexity but with increased overhead.

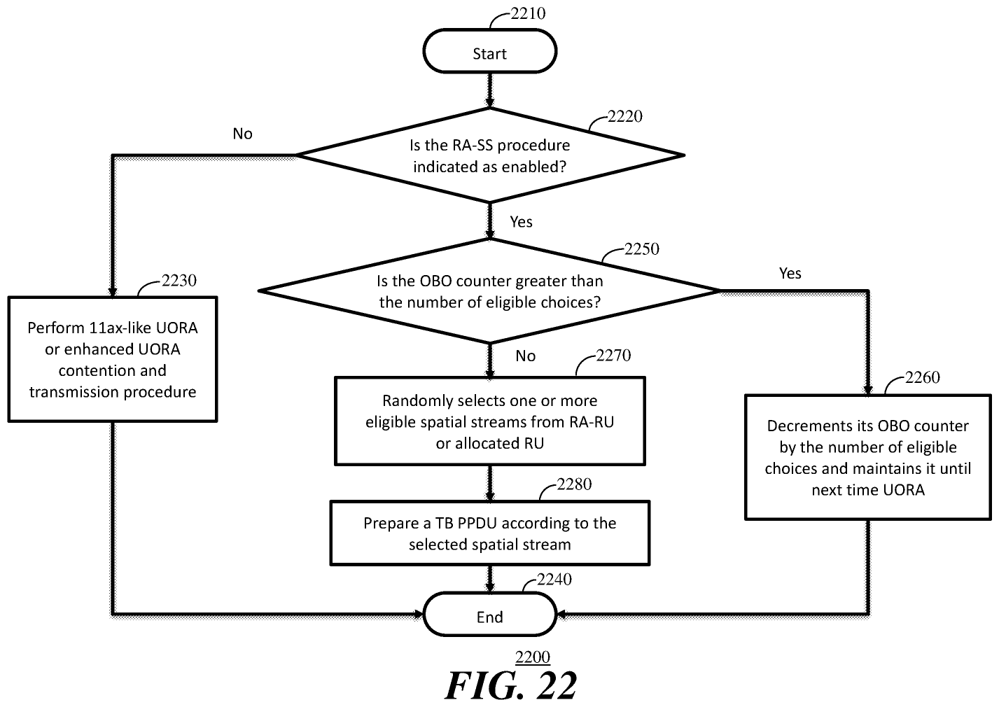

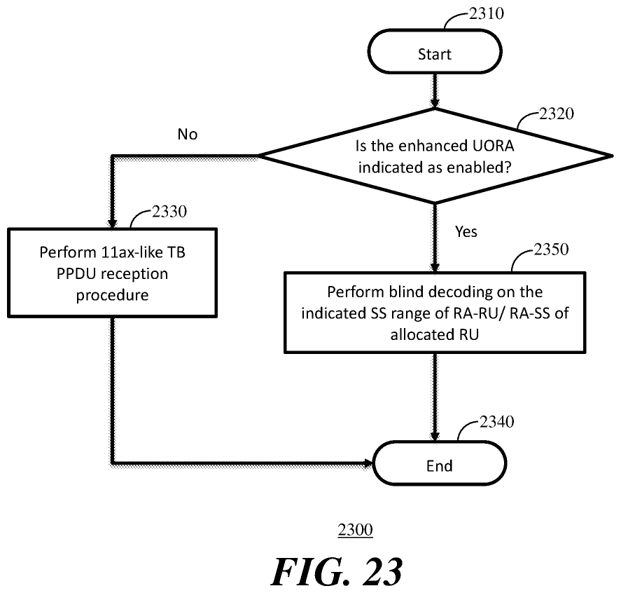

FIG. 22 is a flowchart 2200 of a TB PPDU transmission procedure performed by a STA when receiving a Trigger frame with RA-SS assignment and the STA satisfies the condition for UORA transmission. The TB PPDU transmission procedure starts 2210 by the STA 120 determining 2220 whether the RA-SS procedure is indicated as enabled. If the RA-SS procedure is not indicated as enabled 2220, an IEEE 802.11ax-like UORA contention and transmission procedure is performed 2230 and the TB PPDU transmission procedure ends 2240.

If the RA-SS procedure is indicated as enabled 2220, the TB PPDU transmission procedure determines 2250 whether the OBO counter is greater than the number of eligible choices. If the OBO counter is greater than the number of eligible choices 2250, the OBO counter is decremented 2260 by the number of eligible choices and the OBO counter value is maintained until a next UORA. Then the TB PPDU transmission procedure ends 2240.

If the OBO counter is not greater than the number of eligible choices 2250, one or more eligible spatial streams (SSs) are randomly selected from the RA-RUs or form an allocated RU 2270. A TB PPDU is then prepared 2280 according to the selected spatial stream and the TB PPDU transmission procedure ends 2240 by transmitting the TB PPDU.

FIG. 23 is a flowchart 2300 of a TB PPDU reception procedure performed by the AP 110 in accordance with the present disclosure when one or more RA-RU are assigned. The TB PPDU reception procedure starts 2310 by the AP 110 determining 2320 whether the enhanced UORA procedure is indicated as enabled. If the enhanced UORA procedure is not indicated as enabled 2320, an IEEE 802.11ax-like TB PPDU reception procedure is performed 2330 and the TB PPDU reception procedure ends 2340.

If the enhanced UORA procedure is indicated as enabled 2320, the TB PPDU reception procedure performs blind decoding on the indicated SS range of RA-RU and RA-SS of allocated RUs 2350. Then the TB PPDU reception procedure at the AP 110 ends 2340.

A variant of the TB PPDU reception process discussed above includes nonrandom selection of the RU. When post-HE TB PPDU are solicited, a post-HE STA may select a RA-RU subject to capabilities indicated in the Trigger frame, following specific decision criteria. The possible specific decision criteria may be an Index of the RA-RU is selected based on the result of the STA's AID mod and the number of RA-RUs. In some scenarios where the AIDs of target STAs are contiguous, the collision rate may be decreased as compared to conventional UORA. Note that this variant is only applicable to associated STAs.

Thus, it can be seen that the exemplary embodiments provide multiple structures and methods to enable enhanced random access of AP controlled resources to reduce collisions and increase throughput and efficiency, particularly in high density WLAN environments.

The present disclosure can be realized by software, hardware, or software in cooperation with hardware. Each functional block used in the description of each embodiment described above can be partly or entirely realized by a large-scale integration (LSI) such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing. If future integrate circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more amplifiers, RF modulators/demodulators and the like, and one or more antennas. The processing/control circuitry may include power management circuitry which may comprise dedicated circuitry, a processor and instructions for power management control as either firmware or instructions stored in a memory coupled to the processor.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such an access point, and any other apparatus, device or system that communicates with or controls apparatuses such as those in the non-limiting examples provided herein.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the STA communication apparatus and/or the AP communication apparatus described in the exemplary embodiments without departing from the scope of the present disclosure as set forth in the appended claims.
1. A communication apparatus comprising:
a transceiver, which in operation, receives signals from and transmits signals to at least one access point in a wireless local area network (WLAN); and
circuitry, which in operation, demodulates and decodes the signals from the at least one access point, the decoded signals comprising a WLAN transmission including a trigger frame wherein the circuitry, in operation, prepares a trigger-based WLAN transmission and contends for one or more spatial streams in one of one or more random access resource units (RA-RUs) in response to enhanced uplink OFDMA-based random access (enhanced UORA) being enabled for the communication apparatus.
2. The communication apparatus in accordance with Claim 1 wherein the circuitry, in operation, once the contention succeeds, randomly selects a single spatial stream in response to capabilities of the communication apparatus and limitations of the trigger frame.
3. The communication apparatus in accordance with Claim 1 wherein the circuitry, in operation, once the contention succeeds, selects a single spatial stream according to specific criteria in response to capabilities of the communication apparatus and limitations of the trigger frame.
4. The communication apparatus in accordance with Claim 1 wherein the one or more spatial streams comprise one or more spatial streams with contiguous index, and wherein the circuitry, in operation, once the contention succeeds, randomly selects the one or more spatial streams with contiguous index in response to capabilities of the communication apparatus and limitations of the trigger frame.
5. The communication apparatus in accordance with Claim 1 wherein the circuitry, in operation, once the contention succeeds, selects the one or more spatial streams with contiguous index according to specific criteria in response to capabilities of the communication apparatus and limitations of the trigger frame.
6. The communication apparatus in accordance with Claim 1 wherein the circuitry, in operation, determines whether the communication apparatus may contend for one or more random access spatial streams, and wherein the circuitry, in operation, contends for a single spare spatial stream in an allocated RU in response to determining that the communication apparatus may contend for the one or more random access spatial streams.
7. The communication apparatus in accordance with Claim 1 wherein the circuitry, in operation, contends for the one or more RA-RUs in response to the UORA being enabled for the communication apparatus and selects a single RA-RU from the one or more RA-RUs in response to specific criteria.
8. A communication apparatus operating as an access point in a wireless local area network (WLAN), the communication apparatus comprising:
a transceiver, which in operation, receives signals from and transmits signals to at least one wireless station in the WLAN; and
circuitry, which in operation, modulates and encodes the signals transmitted to the at least one wireless station, the signals comprising a WLAN transmission including a trigger frame that assigns one or more RA-RUs for enhanced UORA.
9. The communication apparatus in accordance with Claim 8 wherein the circuitry, in operation, generates, modulates and encodes a Management frame which includes a field for enabling the enhanced UORA.
10. The communication apparatus in accordance with Claim 8 wherein the circuitry, in operation, generates, modulates and encodes the trigger frame which includes a field for enabling the enhanced UORA.
11. The communication apparatus in accordance with Claim 8 wherein the circuitry, in operation, applies blind decoding on all eligible spatial streams in the one or more RA-RUs assigned for enhanced UORA.
12. The communication apparatus in accordance with Claim 8 wherein the circuitry, in operation, generates, modulates and encodes the trigger frame which assigns one or more spatial streams for random access in allocated RUs.
13. The communication apparatus in accordance with Claim 12 wherein the circuitry, in operation, applies blind decoding on all eligible ones of the one or more spatial streams.
14. A communication method in a wireless local area network (WLAN) comprising:
receiving signals from at least one access point in the WLAN, the signals comprising a trigger-based WLAN transmission including a trigger frame;
determining whether enhanced uplink OFDMA-based random access (enhanced UORA) is enabled; and
selecting one or more spatial streams in one of one or more random access resource units (RA-RUs) in response to the enhanced UORA being enabled.
15. The communication method of Claim 14 wherein the selecting comprises randomly selecting the one or more spatial streams in one of the one or more RA-RUs in response to limitations of the trigger frame.
16. The communication method of Claim 15 wherein the selecting further comprises selecting the one or more spatial streams according to specific criteria.
17. The communication method of Claim 16 wherein the one or more spatial streams comprise one or more spatial streams with contiguous index.
18. The communication method of Claim 14 further comprising determining whether the communication apparatus may contend for one or more random access spatial streams, and wherein the selecting comprises contending for a single spare spatial stream in an allocated RU in response to determining that the communication apparatus may contend for the one or more random access spatial streams.

What is claimed is:

1. A communication apparatus comprising:
a transceiver, which in operation, receives signals from and transmits signals to at least one access point in a wireless local area network (WLAN); and
circuitry, which in operation, demodulates and decodes the signals from the at least one access point, the decoded signals comprising a WLAN transmission including a trigger frame, wherein the circuitry, in operation, prepares a trigger-based WLAN transmission and contends for one or more spatial streams in one of one or more random access resource units (RA-RUs) in response to enhanced uplink OFDMA-based random access (enhanced UORA) being enabled for the communication apparatus.

2. The communication apparatus in accordance with claim 1 wherein the circuitry, in operation, once the contention succeeds, randomly selects a single spatial stream in response to capabilities of the communication apparatus and limitations of the trigger frame.

3. The communication apparatus in accordance with claim 1 wherein the circuitry, in operation, once the contention succeeds, selects a single spatial stream according to specific criteria in response to capabilities of the communication apparatus and limitations of the trigger frame.

4. The communication apparatus in accordance with claim 1 wherein the one or more spatial streams comprise one or more spatial streams with contiguous index, and wherein the circuitry, in operation, once the contention succeeds, randomly selects the one or more spatial streams with contiguous index in response to capabilities of the communication apparatus and limitations of the trigger frame.

5. The communication apparatus in accordance with claim 1 wherein the circuitry, in operation, once the contention succeeds, selects the one or more spatial streams with contiguous index according to specific criteria in response to capabilities of the communication apparatus and limitations of the trigger frame.

6. The communication apparatus in accordance with claim 1 wherein the circuitry, in operation, determines whether the communication apparatus may contend for one or more random access spatial streams, and wherein the circuitry, in operation, contends for a single spare spatial stream in an allocated RU in response to determining that the communication apparatus may contend for the one or more random access spatial streams.

7. The communication apparatus in accordance with claim 1 wherein the circuitry, in operation, contends for the one or more RA-RUs in response to the UORA being enabled for the communication apparatus and selects a single RA-RU from the one or more RA-RUs in response to specific criteria.

8. A communication apparatus operating as an access point in a wireless local area network (WLAN), the communication apparatus comprising:
a transceiver, which in operation, receives signals from and transmits signals to at least one wireless station in the WLAN; and
circuitry, which in operation, modulates and encodes the signals transmitted to the at least one wireless station, the signals comprising a WLAN transmission including a trigger frame which assigns one or more random access resource units (RA-RUs) for enhanced UORA.

9. The communication apparatus in accordance with claim 8 wherein the circuitry, in operation, generates, modulates and encodes a Management frame which includes a field for enabling the enhanced UORA.

10. The communication apparatus in accordance with claim 8 wherein the circuitry, in operation, generates, modulates and encodes the trigger frame which includes a field for enabling the enhanced UORA.

11. The communication apparatus in accordance with claim 8 wherein the circuitry, in operation, applies blind decoding on all eligible spatial streams in the one or more RA-RUs assigned for enhanced UORA.

12. The communication apparatus in accordance with claim 8 wherein the circuitry, in operation, generates, modulates and encodes the trigger frame which assigns one or more spatial streams for random access in allocated RUs.

13. The communication apparatus in accordance with claim 12 wherein the circuitry, in operation, applies blind decoding on all eligible ones of the one or more spatial streams.

14. A communication method in a wireless local area network (WLAN) comprising:
receiving signals from at least one access point in the WLAN, the signals comprising a WLAN transmission including a trigger frame;
determining whether enhanced uplink OFDMA-based random access (enhanced UORA) is enabled; and
selecting one or more spatial streams in one of one or more random access resource units (RA-RUs) in response to the enhanced UORA being enabled.

15. The communication method of claim 14 wherein the selecting comprises selecting the one or more spatial streams in the one or more RA-RUs in response to limitations of the trigger frame and/or according to specific criteria.
